(19) United States
(12) Patent Application Publication
(10) Pub. No.: US 2010/0268667 A1
(43) Pub. Date: Oct. 21, 2010

(54) VENTURE EXCHANGE SYSTEM

(76) Inventors: Anthony Gerald King, Ann Arbor, MI (US); Adrian Siu-Cheuk Wu, White Plains, NY (US)

Correspondence Address: CARLSON, GASKEY & OLDS, P.C., 400 WEST MAPLE ROAD, SUITE 350, BIRMINGHAM, MI, 48009, US

(21) Appl. No.: 12/732,756

(22) Filed: Mar. 26, 2010

Related U.S. Application Data
(60) Provisional application No. 61/169,830, filed on Apr. 16, 2009.

(51) Int. Cl. G06Q 40/00; G06Q 20/00

(52) U.S. Cl. 705/36 R; 705/37

(57) ABSTRACT

The Venture Exchange System uses a hardware server to connect investors and entrepreneurs over the network. The Exchange system allows the investors to invest money in business plans in a secure fashion and allows the investors to exchange security interests in business plans which they have invested in with other investors using the same system.

### PRIORITY STATEMENT

The application claims priority to U.S. Provisional Application No. 61/169,830 which was filed on Apr. 16, 2009.

### BACKGROUND

The application relates to a method for connecting businesses and entrepreneurs with startup ventures to investors who may wish to invest their capital in these business ventures, and more particularly to matching small businesses and startup ventures that do not have the mean or economy of scale to access the existing capital markets with individuals that can supply the necessary capital to expand their business.

Small businesses, such as local machine shops, neighborhood restaurants, or small merchants, often need capital to meet cash flow obligations, or to expand their business. Entrepreneurs with new ventures or product ideas need capital to “start-up” the business and develop the idea. Currently small businesses or entrepreneurs have limited avenues through which to request capital funding, including sources such as a venture capitalist, banks, friends and neighbors, or even through a relatively new concept called Crowdfunding. However, aside from Crowdfunding, none of these sources open up the investing opportunities to more than a handful of individuals; nor do they allow investment of relatively small dollar amounts. Crowdfunding, although allowing both individual investors and smaller dollar amount contributions, has additional problems since the investor does not know what is being done with the contribution and is not necessarily aware of the progress or future profit potential.

Moreover, trading or exchanging investments with other investors is nearly impossible with any of the above described funding models. More established businesses, on the other hand, can find capital funding through the established capital markets, such as NYSE or NASDAQ. However, most small businesses do not meet the listing requirements nor the economy of scale.

### SUMMARY

This present application provides a system and method for raising capital to fund business development and/or new business ideas. Initially, the System receives a proposed business plan which is then analyzed. If the plan meets certain criteria, it is placed in a database and displayed on a portal. Once displayed, visitors to the portal can invest money into the business plan. When money is invested in this fashion, the System isolates the invested money and disperses at least a portion of the money to an entrepreneur who submitted the business plan. Additionally, the investor is awarded security interests in the business plan, in form of equity, debt or other instruments, which can offer a return on investment.

These and other features of the present invention can be best understood from the following specification and drawings, the following of which is a brief description.

### BRIEF DESCRIPTION OF THE DRAWINGS

FIG. 1 is a block diagrammatic drawing of a venture exchange system for connecting a small business entrepreneur with individual investors in accordance with an example of the present invention.

FIG. 2A is first portion of a flow chart illustrating a method of connecting a small business entrepreneur and the individual investors according to one example of the present invention.

FIG. 2B is second portion of a flow chart illustrating a method of connecting a small business entrepreneur and the individual investors according to one example of the present invention.

FIG. 2C is third portion of a flow chart illustrating a method of connecting a small business entrepreneur and the individual investors according to one example of the present invention.

FIG. 3A is a first portion of a flow chart illustrating a method of connecting an investment management operator and individual investors according to one example of the present invention.

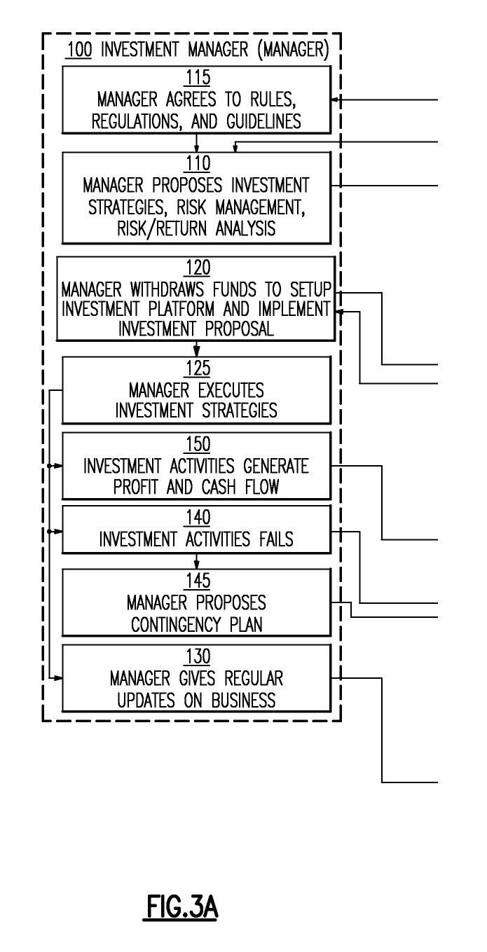

FIG. 3B is a second portion of a flow chart illustrating a method of connecting an investment management operator and individual investors according to one example of the present invention.

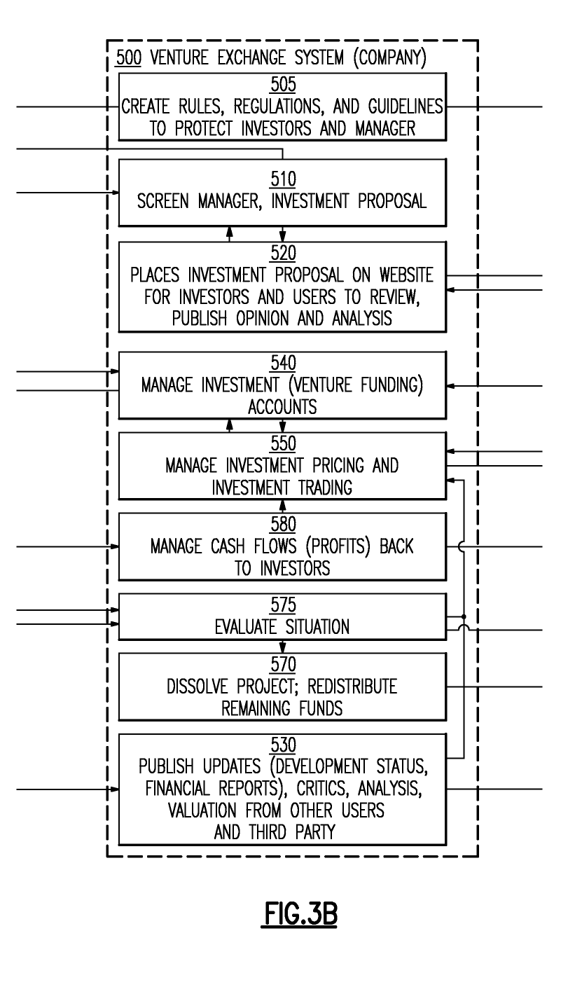

FIG. 3C is a third portion of a flow chart illustrating a method of connecting an investment management operator and individual investors according to one example of the present invention.

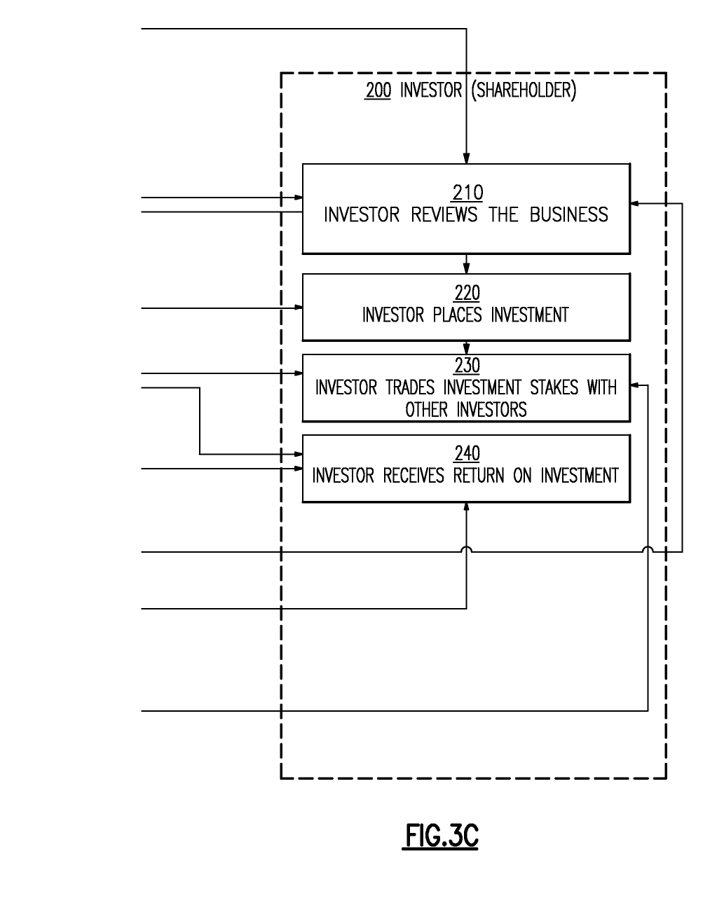

### DETAILED DESCRIPTION

One embodiment of the Venture Exchange System uses a portal on a network to connect an investor with capital to an entrepreneur who owns a business or product idea that needs capital to grow. By way of example, the portal could be a website. Using a network, such as the Internet, greatly increases the potential investor pool, requiring less capital from each individual investor. Investment could consist of equity, debt or other structured investments. The system enforces regular reporting of progress, as well as generation of financial statements, to make the venture development more transparent to investors. The system also allows investors to exchange their investment in the entrepreneur's venture with other investors, with valuations driven by market forces. The system also facilitates cash flows, or profits, to be paid back to investors should the venture succeed. The venture exchange system thus creates a liquid exchange and trading market for investments in small business and new venture enterprises.

A further aspect of the present disclosure allows for a separate area on the portal which would include non-profit projects and humanitarian causes. Another aspect of this disclosure allows for separate areas on the portal for more established business or projects to access the conventional capital markets, separating the really small ideas from larger business proposals. Another aspect of this disclosure allows the portal to provide an area for entrepreneurs to find and hire professional assistance in certain business areas, such as legal, accounting, operations, and others. In this aspect, the portal would allow providers of these services to place advertisements or listings.

While the present disclosure is described with respect to a method and system for connecting a small business entrepreneur with individual investors by buying and selling equity stakes in ventures, the system may be adapted to be used in connecting various other parties including non-profit organizations, large businesses, and institutional investors, and may also be adapted to buying/selling other capital instruments including debt, fund investments, derivatives, etc.

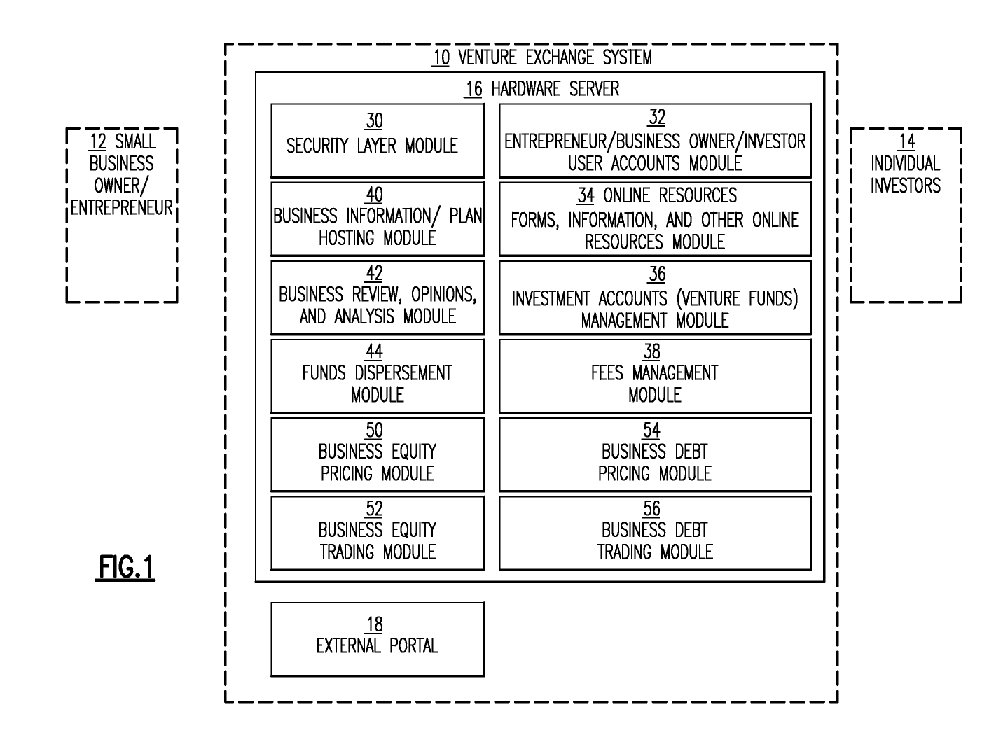

Referring now to FIG. 1, a block diagrammatic view of a venture exchange system 10 for connecting a small business owner/entrepreneur 12 with individual investors 14 is shown in accordance with one example implementation of the disclosed method. The venture exchange system 10 has at least one venture exchange server 16 that is coupled to an external facing portal 18. The Portal 18 communicates data from the Server 16 to the small business owner/entrepreneur 12 and/or the individual investors 14. The Portal 18 also communicates commands executed by the small business owner/entrepreneur 12 and/or individual investors 14 to the Server 16.

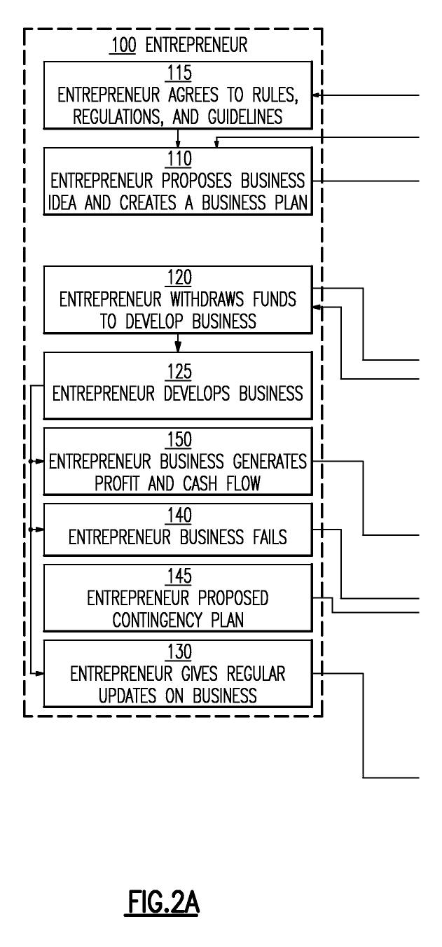

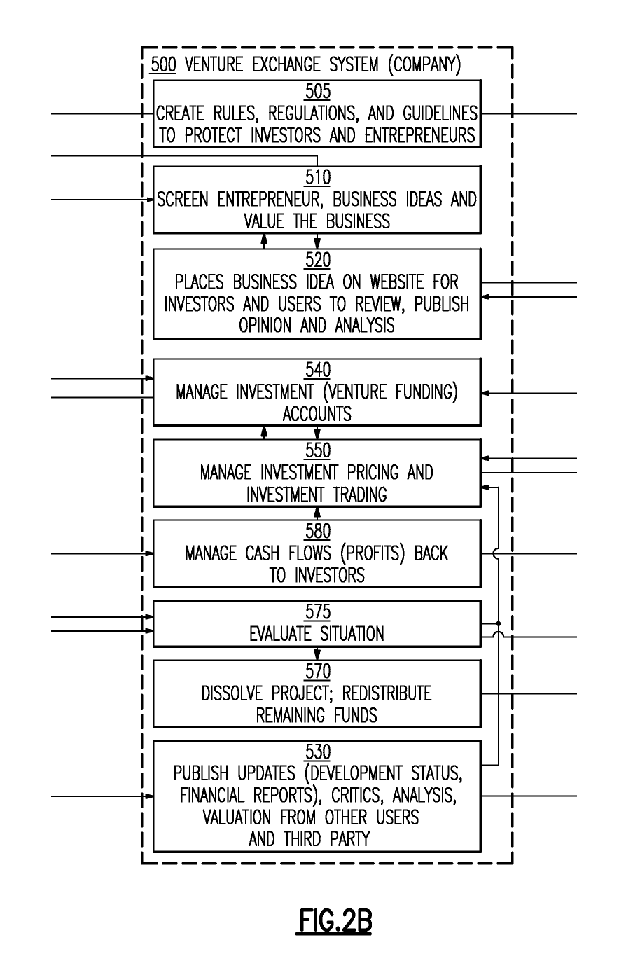

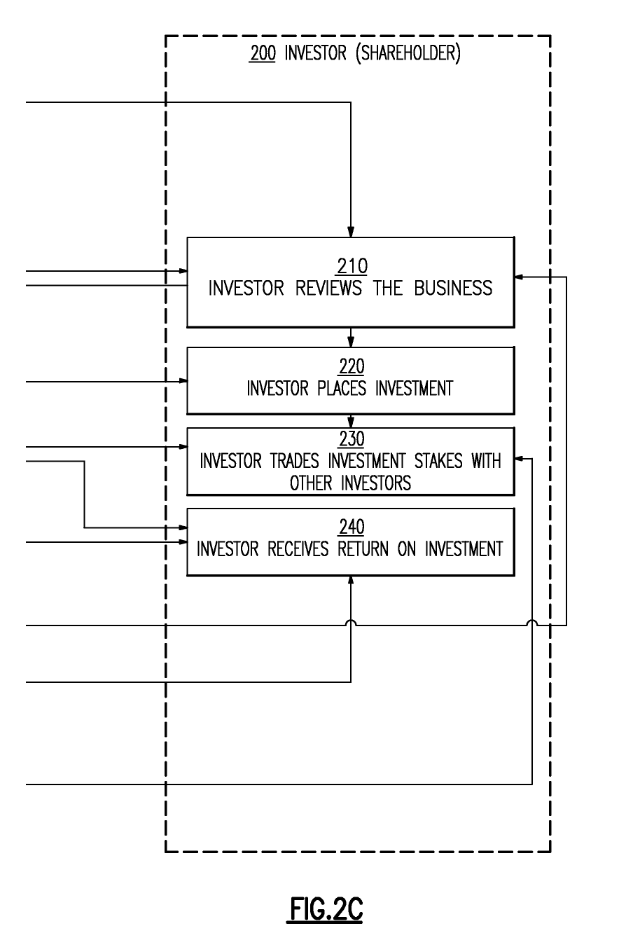

Computer programs typically include individual segments called modules. In a typical system each module contains the code to perform a specific function and is called whenever that function is needed. The Venture Exchange Server 16 may include a Security Layer Module 30, a User Accounts Module 32, an Online Resources Module 34, an Accounts Management Module 36, a Fees Management Module 38, a Plan Hosting Module 40, an Opinions and Analysis Module 42, a Funds Dispersement Module 44, an Equity Pricing Module 50, an Equity Trading Module 52, a Debt Pricing Module 54, and a Debt Trading Module 56. Each of the modules performs a function and can be called or utilized according to the examples of FIGS. 2A-C and 3A-C. Additional modules could be added to perform additional functions as needed.

The Security Layer Module 30 acts to ensure the privacy and security of personal data from the small business owner/entrepreneur 12 and/or individual investors 14, as well as the security of the activities within the venture exchange server. The Security Layer Module 30 additionally generates a data secure message to all the other modules within the Server 16, as well as to the Portal 18 when the data has been properly secured.

The User Accounts Module 32 acts to generate user accounts, manages the account upkeep and status including tracking usage patterns, businesses, investments, and account funds and value. The User Accounts Module 32 also acts as a login module and generates a valid user signal which allows access to the relevant data and interaction portions of the other modules in the sever 16 when a registered user is logged in.

The Online Resources Module 34 maintains forms, information, and other online support resources. The Online Resources module 34 also disperses forms and data in response to a form/data request signal from the Portal 18, as originally requested by the small business owner/entrepreneur 12 and/or individual investors 14 and is capable of outputting a forms and data signal stream to the Portal 18.

The Accounts Management Module 36 maintains money and equity accounts for both business owner/entrepreneur 12 and/or individual investors 14, including firewalling funds of different users to safeguard their assets. The Accounts Management Module 36 updates the value of accounts in response to an equity trade signal from the Equity Trading Module 52, or an equity pricing signal from the Equity Pricing Module 50, or a debt trading signal from the Debt Trading Module 56, or a debt pricing signal from the Debt Pricing Module 54, or a funds dispersed signal from the Funds Dispersement Module 44, or from funds deposited by business owner/entrepreneur 12 and/or individual investors 14.

The Fees Management Module 38 manages the collection of transactions fees, money management fees, and other sources of revenue for the Venture Exchange System, in response to some or all transactions within the System 10 or the Server 16.

The Plan Hosting Module 40 maintains the business plans or other information for startup business owners/entrepreneurs 12 who want access to capital from investors. The Plan Hosting Module 40 accepts new and updated plans or information in response to a new plan signal from the Portal 18 as originally request by the business owner/entrepreneur 12. The Plan Hosting Module 40 will also send plans and other information to the Portal 18 in response to a plan request signal as originally requested by individual investors 14.

The Opinions and Analysis Module 42 allows individual investors 14 to add their reviews, opinions, and analyses on specific businesses and business plans. The reviews, opinions and analyses are updated in response to an update opinions signal from the Portal 18 and the last plan request signal from Business Information/Plan Hosting Module 40. The Opinions and Analysis Module 42 will also send a reviews and opinions signal to the Portal 18 upon request by business owner/entrepreneur 12 and/or individual investors 14.

The Funds Dispersement Module 44 manages dispersement of funds to the business owner/entrepreneur 12 upon request of fund dispersement from the Portal 18. The Funds Dispersement module 44 will also disperse funds to individual investors 14 upon request of a funds request signal from the Portal 18. The Funds Dispersement module 44 will then generate a funds dispersed signal sent to the Accounts Management Module 36.

The Equity Pricing Module 50 re-prices equity based on bid/offer prices for the equity/derivative instruments among investors 14. The Equity Pricing Module 50 can also provide a basic suite of analytical tools, which are available on the Portal 18 after a user has logged in, to help a potential investor to evaluate their investments and make appropriate trading decisions to users. Additionally, third party professional advice may be found by the investor 14 through the online Resources Module 34 on the VX platform to assist investor in their decision making.

The Equity Trading Module 52 executes direct equity purchases of business owner/entrepreneur 12 ventures in response to an equity purchase signal from the Portal 18 as originally requested by individual investors 14. The Equity Trading Module 52 also executes equity trades among individual investors 14 in response to a trade signal from the Portal 18 as originally requested by individual investors 14. After a trade is confirmed, the Equity Trading Module 52 will generate an equity trade signal to be sent to the Accounts Management Module 36.

The Business Debt Pricing Module 54 re-prices debt based on the bid/offer price for the debt/derivative instruments among individual investors 14 as captured in the Business Debt Trading Module 56. The Business Debt Pricing Module 54 can also provide a similar analytical suite to the one described in the Business Equity Pricing Module 50. The Debt Pricing Module 54 also generates a show updated funds value signal to Portal 18 as originally requested by the small business owner/entrepreneur 12 and/or individual investors 14.

The Debt Trading Module 56 executes direct debt purchases of the business owner/entrepreneur 12 ventures in response to a purchase debt signal from the Portal 18 as originally requested by individual investors 14. The Debt Trading Module 56 also executes debt trades among individual investors 14 in response to a trade signal from the Portal 18 as originally requested by individual investors 14. After a trade is confirmed, the Debt Trading Module 56 will generate a debt trade signal to be sent to the Accounts Management Module 36.

Generally the venture exchange method operates such that the investor 200 is connected to the entrepreneur 100 through the Venture Exchange System 500. Initially, an entrepreneur will approach the business seeking investments in a new startup business plan.

The Company can then screen the entrepreneur seeking capital, either automatically by checking against a set of objective criteria, or manually by having an employee review the information provided by the entrepreneur. During the screening, the entrepreneur provides necessary information, such as credit history or criminal background checks, to satisfy certain integrity requirements set forth by the Company. The Company may review the proposed business plan, perform basic due-diligence of business, provide guidance on valuation on the future enterprise, or perform other services as desired. The Company may suggest a form of capital raising—equity, debt or structured investment—to the entrepreneur, and may evaluate the risk and return for potential investors. Based on the initial screening and assessment, the Company may ask the entrepreneur to revise the business plan 110 or the Company could place the plan onto the server for public review and investment 520.

An investor could browse through the business plans 210 on the Portal 18 and publish their opinion, analysis and valuation on the business 520. Their findings can then be criticized, analyzed, and ranked by other investors and users. These ratings and analyses can be used by other investors as another decision factor on whether or not to invest in a venture. This helps eliminate a conflict of interest commonplace in today's investing practice in which analysts in investment shops recommend investment in the same companies they help take public, underwrite debt and other instruments. Based on available information, the investor may then choose to invest in one of the listed ventures 220.

The investor can then send money to the Company, who could escrow the investment funds for the business in a Secured Firebox Account 540. Rule-based dispersion and withdrawal from the Secured Firebox Account is set in place to firebox investments from abusive acts of a rogue entrepreneur. In one example, venture funding is collected in tranches, with a target amount of funding previously identified for each tranche. Once that amount was reached, the venture would be closed to new investors. The rule based dispersion ensures that, once the entrepreneur withdraws funds, the funds can be used for developing the idea or the entrepreneurial business 125. This includes product development, prototype purchases, service purchases, etc.

The entrepreneur prepares regular updates on the business 130 and publishes the updates on the Portal 18. This can include not only written updates on development status, but also regular financial (profit/loss) statements that could be viewed by the investor and other users of the portal. The Company may also require release of certain information from the entrepreneur including, but not limited to, tax returns, business records from the entrepreneur, or other documentation. The Company may perform audits to ensure that the entrepreneur is using the invested funds pursuant to the previously described business plan. Such information may be published to investors and be reviewed by the Company or by a third party. The Company may require the publishing of updates via covenant enforcement, if applicable, or as condition for subsequent release of funds.

Upon further development, an entrepreneur's venture may fail, and the Company can take predefined actions as outlined in the original business plan or in rules and regulation of the Company. If the conditions of such failure have not been pre-defined, a course of action can be determined via voting by existing investors under certain conditions set forth in the original business plan or in the rules and regulations of the Company. The entrepreneur also has an opportunity to layout a course of actions to revive the business or mitigate loss to existing investors. Such proposal can be evaluated by the Company 575, and, in certain cases, by the investors 210. Alternatively, the venture could become successful and begin generating cash flow and profit 150, at which point the Company would direct the cash flow and profit back to the investors 580.

Given the Published Updates 530, investors could also choose to sell their investments to other investors, or purchase investments in other ventures from other investors 230. The Company can facilitate this trading of investment stakes in a secondary market facilitated by the Company. The establishment of secondary market is designed to lower cost for both entrepreneurs and investors by creating a medium term recapture of equity or cash flows in the case of entrepreneurs by purchasing outstanding investment stakes or medium term exits in the case of investors prior to maturity of their investment.

FIGS. 2A-C and 3A-C illustrate a detailed example process for facilitating investing and trading which would utilize the above described software modules and processes according to the illustrated flow chart. Initially a business plan is sent to the Company via the Portal 18 in the Submit Business Plan step 110. When the Company receives the business plan from an entrepreneur through the Portal 18, the Business Plan Module 40 accepts the information and either automatically analyzes the plan or delays performing further operations until an employee has analyzed the plan. Once the plan has been analyzed and approved, either automatically, or by an employee of the Company, the business plan is placed on the Portal 18 in the Publish Business Plan step 520.

Once placed on the Portal 18, the business plan is visible to investors and other users who have created accounts using the Investment Accounts Module 36. At this stage the investors can view the approved business plans on the Portal 18 and select any business plans which the investors 100 wish to invest in, or the investors 100 can post reviews of the posted business plans. Each of these actions are handled by the Investment Accounts Module 36, which also functions as a user accounts module. Once the investor 100 has determined a plan in which he desires to invest, the process moves to the Investment Step 220.

In the Investment Step 220, the investor submits money to the System through the Portal 18. Once the money has been submitted the System moves into the Manage Investment Accounts Step 540. The Manage Investment Accounts Step 540 uses the Investment Accounts Module 36 and the Funds Dispersement module 44 to control and determine the number of security interests in a particular business plan which are awarded to an investor for his investment, and to determine whether a withdrawal of the funds by an entrepreneur is allowable.

If the Manage Investment Step 540 determines that fund withdrawal is allowable, the process proceeds to the Withdraw Funds step 120. In this step, the entrepreneur withdraws funds according to predetermined rules for withdrawal. The step consults the Funds Dispersement module 44 to determine which amounts of the firebox fund can be withdrawn and when the funds can be withdrawn. The Withdraw Funds step 120 can be repeated as many times as there are funds or as often as the rules allow.

After the entrepreneur has withdrawn funds he can use the funds to invest in and grow his business in the Develop Business Step 125. This step can result in multiple possible outcomes. The entrepreneur can generate a profit, thus necessitating a return on the investment to the investors, the entrepreneur can hold the business steady and he can withdraw more funds to attempt to grow the business larger pursuant to the rules of the Funds Dispersement module 44, or the entrepreneur's business can fail.

In the case of a failure, the System moves to the Business Failure Step 140. In the Business Failure Step 140, the System employs any rules for wrapping up the business which were established in the Business Plan Module 40, and then determines any monetary amounts which are owed to the investors by the entrepreneur using the Equity Pricing Module 50, and the Debt Pricing Module 54.

Alternately, if a contingency plan has been set in place, the process moves to the Contingency Plan Step 145. In the Contingency Plan Step 145, the System will follow a predetermined plan for wrapping up the business established by the entrepreneur before the business plan was posted. After the amounts owed have been determined (or the contingency plan has been followed) the System moves to the Evaluate Situation Step 575. During the Evaluate Situation Step 575 the System allows an employee of the company to review the situation and determine the appropriate course of action.

After the Evaluate Situation Step 575, the System enters the Dissolve Project Step 570. In the Dissolve Project Step 570, the funds remaining in the investment account are distributed according to any determinations made in the Evaluate Situation Step 575 and according to the information from the Equity Pricing Module 50 and the Debt Pricing Module 54. Once the funds have been redistributed, the System moves to the return on Investment Step 240. In the return on Investment Step 240, the investor receives a monetary return based on the amount invested. The investment return can be through electronic funds transfer, check, or any other payment method.

If the entrepreneur's business plan does not fail, then the System proceeds from the Develop Business Step 125 to the Update Step 130. In the Update Step 130, the entrepreneur submits updates regarding profits and losses, as well as other status changes to the business plan, through the Portal 18, using the Accounts Management Module 36. The updates are then published on the Portal 18 along with the reviews entered by other investors in the Publish Updates Step 530.

The Manage Investment Accounts Step 540 branches into the Manage Investment Pricing and Trading Step 550, in addition to branching to the Withdraw Funds step 120. In the Manage Investment Pricing and Trading Step 550, the System utilizes the Equity Pricing Module 50, the Equity Trading Module 52, the Debt Pricing Module 54, and the Debt Trading Module 56, to allow the investors to propose trades of security interests in business plans which they posses for money or security interests in other posted business plans. The Manage Investment Pricing and Trading Step 550 additionally handles any dispersements which need to be directed from the business to the investors as a result of profits realized in the Manage Profits Step 580.

While the above described method is for investing in a startup business plan, it is recognized that the same method and system can be utilized in conjunction with an investment plan (such as an investment manager) or with a non-profit organization, with only slight modifications to the method.

Although an example embodiment has been disclosed, a worker of ordinary skill in this art would recognize that certain modifications would come within the scope of this invention. For that reason, the following claims should be studied to determine the true scope and content of this invention.

What is claimed is:

1) A method for connecting investors and investees comprising the steps of:
receiving a business plan profile from an entrepreneur;
determining if said business plan profile meets a set of objective criteria;
placing said business plan in a database comprising investable business plan profiles when said objective criteria are met;
displaying business plan profiles in said database on a portal in response to a user request;
receiving investment money from an investor, associating said investment money with said business plan, and issuing an amount of security interests in said business plan profile to said investor where said amount of security interests is proportional to said investment money;
isolating all invested money associated with a business plan in a secure firebox account, controlled by a fiduciary separate from investors and investees; and
distributing a portion of said money from said secured firebox account to an entrepreneur associated with the business plan associated with said money when a set of predetermined conditions are met.

2) The method of claim 1, wherein said business plan comprises an investment management plan.

3) The method of claim 1, wherein said business plan comprises a startup business plan.

4) The method of claim 1, additionally comprising the step of accepting a users review and ranking of a business plan profile.

5) The method of claim 4, additionally comprising the step of posting said review and ranking on said portal.

6) The method of claim 1, additionally comprising the step of accepting a business plan profile update from said entrepreneur and modifying said business plan profile to conform with said business plan profile update.

7) The method of claim 1, additionally comprising the step of displaying advertisements relevant to said business plan profile alongside said business plan profiles on said portal.

8) The method of claim 1, wherein said security interests comprise at least one of debt based security interests, equity based security interests, or structured form security interests.

9) The method of claim 1, wherein said portal is connected to a network of people and organizations.

10) A method for connecting investors and investees comprising the steps of:
receiving a business plan profile from an entrepreneur;
determining if said business plan profile meets a set of objective criteria;
placing said business plan in a database comprising investable business plan profiles when said objective criteria are met;
displaying business plans in said database on a portal in response to a user request;
receiving investment money from an investor, associating said investment money with said business plan profile, and issuing an amount of security interests in said business plan profile to said investor where said amount of security interests is proportional to said investment money;
providing an interface on said portal where at least a first and second investor may post security interests owned for trade;
providing an interface on said portal where said at least a first and second investor may browse said posted security interests for trade; and
facilitating an exchange of posted security interests between said at least a first and second investor.

11) The method of claim 10, wherein said business plan profile comprises an investment management plan.

12) The method of claim 10, wherein said business plan profile comprises a startup business plan.

13) The method of claim 10, wherein said portal is connected to a network of people and organizations.

14) The method of claim 10, wherein said security interests comprise at least one of debt based security interests, equity based security interests, or structured form security interests.

15) A system for connecting investors and investees comprising;
a central hardware server;
a user interface connected to said central hardware server through the network; and
said central hardware server comprising a computer readable medium storing instructions for performing the steps of:
receiving a business plan profile from an entrepreneur;
determining if said business plan profile meets a set of objective criteria;
placing said business plan profile in a database comprising investable business plans when said objective criteria are met;
displaying business plan profiles in said database on a portal in response to a user request;
receiving investment money from an investor, associating said investment money with said business plan profile, and issuing an amount of security interests in said business plan profile to said investor where said amount of security interests is proportional to said investment money;
providing an interface on said portal where a first and second investor may post security interests owned for trade.

16) The system of claim 15, wherein said computer readable medium further comprises instructions for performing the step of providing an interface on said portal where said first and second investor may browse said posted security interests for trade.

17) The system of claim 16, wherein said computer readable medium further comprises instructions for performing the step of facilitating an exchange of posted security interests between said first and second investor.

18) The system of claim 15, wherein said computer readable medium further comprises instructions for performing the step of isolating all invested money associated with a business plan in a secure firebox account.

19) The system of claim 18, wherein said computer readable medium further comprises instructions for performing the step of distributing a portion of said money from said secured firebox account to an entrepreneur associated with the business plan associated with said money when a set of predetermined conditions are met.

20) The system of claim 15, wherein said security interests comprise at least one of debt based security interests, equity based security interests, or structured form security interests.
